(19) United States
(12) Patent Application Publication
(10) Pub. No.: US 2026/0227659 A1
(43) Pub. Date: Aug. 6, 2026

(54) DIMMING ASSEMBLY, BACKLIGHT MODULE, AND DISPLAY DEVICE

(71) Applicants: Nanjing BOE Display Technology CO., LTD., Nanjing,Jiangsu (CN); BOE Technology Group Co., Ltd., Beijing (CN)

(72) Inventors: Minghui ZHANG, Beijing (CN); Lei LIU, Beijing (CN); Yao ZHANG, Beijing (CN); Dongyu LIU, Beijing (CN); Hui GUO, Beijing (CN)

(21) Appl. No.: 19/151,337

(22) PCT Filed: Jun. 18, 2024
(86) PCT No.: PCT/CN2024/099761

§ 371 Date: Jul. 28, 2025

(30) Foreign Application Priority Data
Jul. 28, 2023 (CN) 202310945749.2

(51) Int. Cl. G02F 1/1335

(52) U.S. Cl. CPC G02F 1/133607

(57) ABSTRACT

A dimming assembly, comprising: a first prism sheet and a second prism sheet arranged opposite to each other. The first prism sheet has a first surface and a second surface opposite to each other, and the first surface comprises multiple first dimming portions which extend in a first direction and are arranged in an array. The first prism sheet further has at least one first side surface which extends in a third direction and is connected to the first surface and the second surface, and the included angle between the third direction and the first direction is a first cutting angle of the first prism sheet. The absolute value of the first cutting angle is greater than or equal to 20 degrees and less than or equal to 40 degrees. The second prism sheet has a third surface and a fourth surface opposite to each other.

### CROSS-REFERENCE TO RELATED APPLICATION

The present application is a U.S. National Phase Entry of International Application No. PCT/CN2024/099761 having an international filing date of Jun. 18, 2024, which claims priority of Chinese Patent Application No. 202310945749.2, filed to the CNIPA on Jul. 28, 2023 and entitled “Dimming Assembly, Backlight Module, and Display Device”. Contents of the above-identified applications are incorporated herein by reference.

### TECHNICAL FIELD

The present disclosure relates to, but is not limited to, the field of display technologies, and in particular to a dimming assembly, a backlight module, and a display device.

### BACKGROUND

With development of technology, displays have been widely used in different fields and are inseparable from people's work, study and life. Nowadays, people's demands for performance of displays are getting higher and higher. How to create products with higher brightness and higher picture quality is a major challenge for the display industry. Especially the high-dynamic range (HDR) standard has emerged in recent years. Compared with the Standard Dynamic Range (SDR), HDR can provide higher brightness, better contrast, color accuracy and more vivid colors. However, there are many technical difficulties for liquid crystal display manufacturers when achieving HDR standards. Sacrificing the module viewing angle in order to achieve high brightness is one of the common technical problems in the industry.

### SUMMARY

The following is a summary of subject matters described herein in detail. This summary is not intended to limit the protection scope of claims.

An embodiment of the present disclosure provides a dimming assembly, a backlight module and a display device.

In one aspect, the present embodiment provides a dimming assembly including: a first prism sheet and a second prism sheet arranged opposite to each other. The first prism sheet has a first surface and a second surface opposite to each other, and the first surface includes multiple first dimming portions which extend in a first direction and are arranged in an array. The first prism sheet further has at least one first side surface which extends in a third direction and connects the first surface and the second surface. An included angle between the third direction and the first direction is a first cutting angle of the first prism sheet. An absolute value of the first cutting angle is greater than or equal to 20 degrees and less than or equal to 40 degrees. The second prism sheet has a third surface and a fourth surface opposite to each other. The third surface is located on a side of the second prism sheet close to the first prism sheet. The third surface includes multiple second dimming portions which extend in a second direction and are arranged in an array. An included angle between the first direction and the second direction is greater than 0 degree and less than 90 degrees.

In some exemplary implementations, the absolute value of the first cutting angle is greater than or equal to 25 degrees and less than or equal to 33 degrees.

In some exemplary implementations, the included angle between the first direction and the second direction ranges from 65 degrees to 75 degrees.

In some exemplary implementations, the second prism sheet has at least one second side surface which extends in the third direction and connects the third surface and the fourth surface, and an included angle between the third direction and the second direction is a second cutting angle of the second prism sheet. An absolute value of the second cutting angle is greater than the absolute value of the first cutting angle.

In some exemplary implementations, a difference between the absolute value of the second cutting angle and the absolute value of the first cutting angle ranges from 10 degrees to 70 degrees.

In some exemplary implementations, the absolute value of the second cutting angle is greater than or equal to 50 degrees and less than or equal to 90 degrees.

In some exemplary implementations, the absolute value of the second cutting angle is greater than or equal to 65 degrees and less than or equal to 80 degrees.

In some exemplary implementations, refractive indices of the first dimming portions of the first prism sheet and the second dimming portions of the second prism sheet range from 1.45 to 1.7.

In some exemplary implementations, refractive indices of the first dimming portions of the first prism sheet and the second dimming portions of the second prism sheet range from 1.5 to 1.6.

In some exemplary implementations, a haze of the first prism sheet and a haze of the second prism sheet range from 10% to 45%.

In some exemplary implementations, an absolute value of a difference between the haze of the first prism sheet and the haze of the second prism sheet ranges from 5% to 30%.

In some exemplary implementations, each first dimming portion of the first prism sheet has two first extension surfaces extending in the first direction. In a cross section perpendicular to the second surface and perpendicular to the first direction, an included angle between the two first extension surfaces ranges from 87 degrees to 92 degrees.

In some exemplary implementations, each second dimming portion of the second prism sheet has two second extension surfaces extending in the second direction. In a cross section perpendicular to the fourth surface and perpendicular to the second direction, an included angle between the two second extension surfaces ranges from 87 degrees to 92 degrees.

In some exemplary implementations, the dimming assembly further includes a diffuser located on a side of the second prism sheet away from the first prism sheet and configured to diffuse transmitted light and to direct diffused light toward the second prism sheet.

In some exemplary implementations, the dimming assembly further includes a dual brightness enhancement film located on a side of the first prism sheet away from the second prism sheet.

In another aspect, the present embodiment provides a backlight module including a light source assembly and the dimming assembly as described above. The light source assembly is configured to generate light directed towards the dimming assembly.

In still another aspect, the present embodiment provides a display device including the backlight module as described above and a liquid crystal panel located on a light-emitting side of the backlight module.

Other aspects of the present disclosure may be comprehended after the drawings and the detailed descriptions are read and understood.

### BRIEF DESCRIPTION OF DRAWINGS

Accompanying drawings are used for providing further understanding of technical solutions of the present disclosure, constitute a portion of the specification, and are used for explaining the technical solutions of the present disclosure together with embodiments of the present disclosure, but do not constitute limitations on the technical solutions of the present disclosure.

FIG. 1 is a full viewing angle distribution diagram of a backlight module using two prism sheets with perpendicular prism angles.

FIG. 2 is a schematic diagram of a dimming assembly according to at least one embodiment of the present disclosure.

FIG. 3 is a schematic cross-sectional view of a first prism sheet according to at least one embodiment of the present disclosure.

FIG. 4 is a schematic cross-sectional view of a second prism sheet according to at least one embodiment of the present disclosure.

FIG. 5 is a schematic top view of a first prism sheet according to at least one embodiment of the present disclosure.

FIG. 6 is a schematic top view of a second prism sheet according to at least one embodiment of the present disclosure.

FIG. 7A is a schematic diagram of a display area of a liquid crystal panel according to at least one embodiment of the present disclosure.

FIG. 7B is an observation view of the liquid crystal panel shown in FIG. 7A when measuring a horizontal viewing angle.

FIG. 7C is an observation view of the liquid crystal panel shown in FIG. 7A when measuring a vertical viewing angle.

FIG. 8 is a schematic diagram of a dimming assembly according to at least one embodiment of the present disclosure.

FIG. 9 is a schematic diagram showing an influence of a refractive index of a dimming portion of a prism sheet on a viewing angle.

FIG. 10 is a schematic diagram showing an influence of a haze of a prism sheet on a viewing angle.

FIG. 11 is a graph of a haze of a prism sheet influencing a viewing angle.

FIG. 12 is a brightness full viewing angle distribution diagram after a first prism sheet and a second prism sheet of a dimming assembly are rotated simultaneously.

FIG. 13 is a brightness full viewing angle distribution diagram after a second prism sheet of a dimming assembly is fixed and a first prism sheet is rotated.

FIG. 14 is a brightness full viewing angle distribution diagram after a first prism sheet of a dimming assembly is fixed and a second prism sheet is rotated.

FIG. 15A is a graph showing a change in TCO horizontal viewing angle uniformity after a second prism sheet is rotated in a clockwise direction.

FIG. 15B is a graph showing a change in TCO vertical viewing angle uniformity after a second prism sheet is rotated in a clockwise direction.

FIG. 16A is a graph showing a change in TCO horizontal viewing angle uniformity after a second prism sheet is rotated in a counterclockwise direction.

FIG. 16B is a graph showing a change in TCO vertical viewing angle uniformity after a second prism sheet is rotated in a counterclockwise direction.

FIG. 17A is a graph of TCO viewing angle uniformity as a function of a rotation angle of a second prism sheet.

FIG. 17B is a graph of brightness as a function of an included angle between a first prism in sheet and a second prism sheet.

FIG. 18 is a brightness full viewing angle distribution diagram taking into account an influence of an included angle between a first prism sheet and a second prism sheet and refractive indices of a first dimming portion and a second dimming portion.

FIG. 19 is another schematic diagram of a dimming assembly according to at least one embodiment of the present disclosure.

FIG. 20 is a schematic diagram of a display device according to at least one embodiment of the present disclosure.

### DETAILED DESCRIPTION

The embodiments of the present disclosure will be described below with reference to the drawings in detail. Implementations may be implemented in multiple different forms. Those of ordinary skills in the art may easily understand such a fact that modes and contents may be transformed into other forms without departing from the purpose and scope of the present disclosure. Therefore, the present disclosure should not be explained as being limited to the contents recorded in the following implementations only. The embodiments and features in the embodiments of the present disclosure may be randomly combined with each other if there is no conflict.

In the drawings, a size of one or more constituent elements, a thickness of a layer, or a region is sometimes exaggerated for clarity. Therefore, one mode of the present disclosure is not necessarily limited to the size, and a shape and a size of one or more components in the drawings do not reflect an actual scale. In addition, the accompanying drawings schematically illustrate ideal examples, and an implementation of the present disclosure is not limited to shapes, numerical values, or the like shown in the drawings.

Ordinal numerals “first”, “second”, “third” and the like in the specification are set not to form limits in numbers but only to avoid confusion between constituent elements. In the present disclosure, “a plurality of/multiple” represents two or more than two.

In the specification, for convenience, expressions “central”, “above”, “below”, “front”, “back”, “vertical”, “horizontal”, “top”, “bottom”, “inside”, “outside” and the like for indicating directional or positional relationships are used to illustrate positional relationships between the constituent elements with reference to the accompanying drawings, not to indicate or imply that involved devices or elements are required to have specific orientations or are structured and operated in the specific orientations but only to easily describe the present specification and simplify the description, and thus should not be understood as limitations on the present disclosure. The positional relationships between the constituent elements are changed as appropriate according to directions of the constituent elements described. Therefore, appropriate replacements based on situations are allowed, which is not limited to the expressions in the specification.

In the specification, unless otherwise explicitly specified and defined, terms “mounting”, “coupling”, and “connection” should be understood in a broad sense. For example, it may be a fixed connection, a detachable connection, or an integral connection; it may be a mechanical connection or a connection; it may be a direct connection, an indirect connection through a middleware, or an internal communication between two elements. Those of ordinary skills in the art may understand meanings of the aforementioned terms in the present disclosure according to situations.

In the specification, “parallel” refers to a state in which an angle formed by two straight lines is above−10° and below 10°, and thus may include a state in which the angle is above−5° and below 5°. In addition, “perpendicular” refers to a state in which an angle formed by two straight lines is above 80° and below 100°, and thus may include a state in which the angle is above 85° and below 95°.

In the specification, a circle, oval, triangle, rectangle, trapezoid, pentagon, or hexagon, or the like is not strictly defined, but may be an approximate circle, oval, triangle, rectangle, trapezoid, pentagon, or hexagon, or the like. Some small deformations due to tolerances may exist, for example, chamfers, arc edges, and deformations may exist.

In the present disclosure, “about” and “substantially” means that a boundary is not defined strictly and a case within a range of process and measurement errors is allowed. In the present disclosure, “substantially the same” refers to a case where numerical values differ by less than 10%. “Symmetry” in the present disclosure means that a boundary is not defined strictly and a case where approximate symmetry within a range of process and measurement errors is allowed.

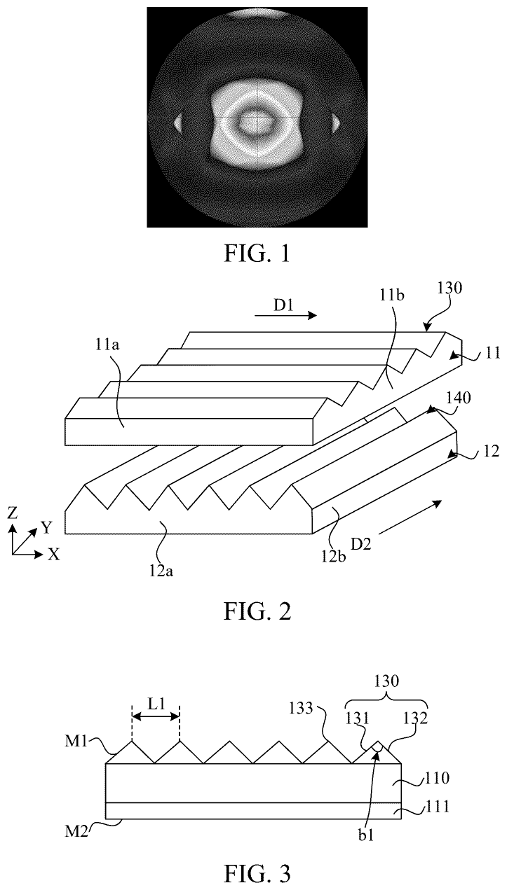

In some implementations, a liquid crystal display device mainly includes a backlight module and a liquid crystal panel disposed on a light-emitting side of the backlight module. The backlight module may provide a surface light source to the liquid crystal panel, so that the liquid crystal panel may display images normally. The backlight module mainly includes a light source assembly and a dimming assembly disposed on a light-emitting side of the light source assembly. When displaying, light emitted by the light source assembly passes through the dimming assembly and then is directed to the liquid crystal panel, so that the liquid crystal panel may display images normally. The dimming assembly typically employs an optical film prism sheet, which may utilize optical refraction to form a brightness increase in a central viewing angle. For example, the dimming assembly may adopt two stacked prism sheets whose prism angles are perpendicular to each other (for example, a cutting angle of an upper prism sheet is 0 degree, and a cutting angle of a lower prism sheet is 90 degrees) to converge light in both horizontal and vertical directions to a front viewing angle (i.e., 0-degree viewing angle), thereby improving display brightness in the front viewing angle and enabling the liquid crystal display device to obtain higher brightness gain. FIG. 1 is a full viewing angle distribution diagram of a backlight module using two prism sheets with perpendicular prism angles. In the full viewing angle distribution diagram, the abscissa axis represents a horizontal viewing angle, the ordinate axis represents a vertical viewing angle, and different brightness is represented by different gray levels. As shown in FIG. 1, the brightness of the large viewing angle has dropped significantly, and there is a problem that neither the horizontal viewing angle nor the vertical viewing angle can reach a good state. Due to the effect of the prism sheet, while increasing the brightness of the front viewing angle, the viewing angle distribution will be seriously affected, causing the viewing angle and brightness of the backlight module to restrict each other, unable to balance requirements of the viewing angle and brightness, and unable to meet the standards of Tjästemännens Central Organization (TCO), thus affecting the consumer experience. TCO standard is a display certification standard promoted by Tjästemännens Central Organization, which is recognized as one of the most popular certifications in the display industry at present.

The present embodiment provides a dimming assembly, a backlight module, and a display device, which can balance the requirements of brightness and viewing angle, and obtain good brightness gain while meeting the requirements of TCO viewing angle.

The present embodiment provides a dimming assembly, which includes a first prism sheet and a second prism sheet arranged opposite to each other. The first prism sheet has a first surface and a second surface opposite to each other, and the first surface includes multiple first dimming portions which extend in a first direction and are arranged in an array. The first prism sheet has at least one first edge extending in a third direction, and an included angle between the third direction and the first direction is a first cutting angle of the first prism sheet. An absolute value of the first cutting angle is greater than or equal to 20 degrees and less than or equal to 40 degrees. The second prism sheet has a third surface and a fourth surface opposite to each other. The third surface is located on a side of the second prism sheet close to the first prism sheet. The third surface includes multiple second dimming portions which extend in a second direction and are arranged in an array. An included angle between the first direction and the second direction is greater than 0 and less than 90 degrees.

In this example, positive or negative of an angle indicates a direction of rotation that forms the angle, but not a magnitude of the angle. A positive angle represents an angle formed by counterclockwise rotation, and a negative angle represents an angle formed by clockwise rotation.

In the dimming assembly provided in the present embodiment, by setting an angle range of the first cutting angle of the first prism sheet and an angle range of the included angle between an extension direction of the first dimming portion of the first prism sheet (that is, the first direction) and an extension direction of the second dimming portion of the second prism sheet (that is, the second direction), the TCO viewing angle requirement can be met while achieving good brightness gain, thereby being beneficial to improving the performance of the display product.

In some exemplary implementations, the absolute value of the first cutting angle may be greater than or equal to 25 degree and less than or equal to 33 degrees. In the present example, it may facilitate achieving the TCO horizontal viewing angle requirement by setting the angle range of the first cutting angle.

In some exemplary implementations, the included angle between the first direction and the second direction may range from 65 degrees to 75 degrees, for example, it may be about 70 degrees. In this example, by setting the size of the included angle between the first direction and the second direction, it is possible to facilitate compatible realization of the requirements of brightness and viewing angle.

In some exemplary implementations, the second prism sheet has at least one second edge extending in a third direction, and an included angle between the third direction and the second direction is a second cutting angle of the second prism sheet. An absolute value of the second cutting angle may be greater than an absolute value of the first cutting angle. In some examples, a difference between the absolute value of the second cutting angle and the absolute value of the first cutting angle may range from 10 degrees to 70 degrees. In some examples, the absolute value of the second cutting angle may be greater than or equal to 50 degrees and less than or equal to 90 degrees. For example, the absolute value of the second cutting angle may be greater than or equal to 65 degrees and less than or equal to 80 degrees. By setting the absolute value of the second cutting angle to be greater than or equal to 65 degrees, the situation where the brightness loss is serious can be improved, and by setting the absolute value of the second cutting angle to be less than or equal to 80 degrees, the situation where the TCO viewing angle requirement cannot be met can be avoided.

In some exemplary implementations, the refractive indices of the first dimming portions of the first prism sheet and the second dimming portions of the second prism sheet may range from 1.45 to 1.7, that is, the refractive indices of the first dimming portions of the first prism sheet and the second dimming portions of the second prism sheet may be greater than or equal to 1.45 and less than or equal to 1.7. In some examples, the refractive indices of the first dimming portions of the first prism sheet and the second dimming portions of the second prism sheet may range from 1.5 to 1.6, that is, the refractive indices of the first dimming portions of the first prism sheet and the second dimming portions of the second prism sheet may be greater than or equal to 1.5 and less than or equal to 1.6. By increasing the refractive indices of the dimming portions, it is advantageous to improve brightness and TCO viewing angle uniformity. Further, when the refractive index of the material used for the dimming portions is greater than 1.6, the scratch resistance decreases significantly, and by setting the refractive index to be greater than 1.6, the scratch resistance of the prism sheet can be advantageously improved.

In some exemplary implementations, a haze of the first prism sheet and a haze of the second prism sheet may be the same or different. In some examples, the haze of the first prism sheet and the second prism sheet may range from 10% to 45% (i.e. greater than or equal to 10% and less than or equal to 45%). In some examples, the absolute value of the difference in the haze of the first prism sheet and the second prism sheet may range from 5% to 30%. In some examples, the haze of the first prism sheet may range from 15% to 30% (i.e., greater than or equal to 15% and less than or equal to 30%), and the haze of the second prism sheet may range from 25% to 45% (i.e., greater than or equal to 25% and less than or equal to 45%). When the haze of the first prism sheet is less than 15%, the shielding property is poor, and when the haze of the first prism sheet is greater than 30%, the brightness loss is significant. When the haze of the second prism sheet is less than 25%, the requirement of TCO viewing angle cannot be met, and when the haze of the second prism sheet is greater than 45%, the brightness loss is significant. The haze ranges of the first prism sheet and the second prism sheet of the present example may be advantageous to compatibly achieve requirements of brightness and viewing angle.

In some exemplary implementations, the first dimming portion of the first prism sheet may have two first extension surfaces extending in the first direction. In a cross section perpendicular to the second surface of the first prism sheet and perpendicular to the first direction, an included angle between the two first extension surfaces may range from 87 degrees to 92 degrees, for example, the included angle between the two first extension surfaces may be about 90 degrees. The second dimming portion of the second prism sheet may have two second extension surfaces extending in the second direction. In a cross section perpendicular to the fourth surface of the second prism sheet and perpendicular to the second direction, an included angle between the two second extension surfaces may range from 87 degrees to 92 degrees, for example, the included angle between the two second extension surfaces may be about 90 degrees. In this example, by setting the angle ranges of the two first extension surfaces of the first dimming portion and the angle ranges of the two second extension surfaces of the second dimming portion, it is advantageous to realize higher brightness.

The solution of the present embodiment will be illustrated below through some examples.

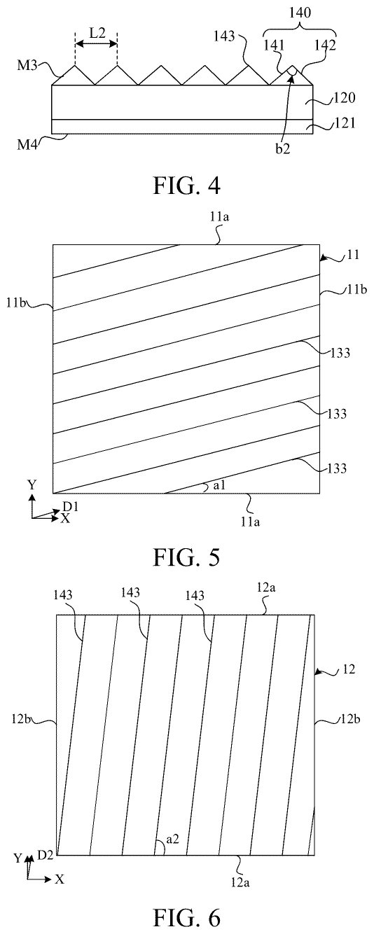

FIG. 2 is a schematic diagram of a dimming assembly according to at least one embodiment of the present disclosure. FIG. 3 is a schematic cross-sectional view of a first prism sheet according to at least one embodiment of the present disclosure. FIG. 4 is a schematic cross-sectional view of a second prism sheet according to at least one embodiment of the present disclosure. FIG. 5 is a schematic top view of a first prism sheet according to at least one embodiment of the present disclosure. FIG. 6 is a schematic top view of a second prism sheet according to at least one embodiment of the present disclosure. FIG. 3 shows a cross section of the first prism sheet perpendicular to a second surface M2 and perpendicular to a first direction D1. FIG. 4 shows a cross section of the second prism sheet perpendicular to a fourth surface M4 and perpendicular to a second direction D2.

In some examples, as shown in FIGS. 2 to 6, the dimming assembly of the present example may include a first prism sheet 11 and a second prism sheet 12 arranged opposite to each other. For example, the second prism sheet 12 and the first prism sheet 11 may be sequentially provided on a light-emitting side of a light source assembly. The first prism sheet 11 may be located on a light-emitting side of the second prism sheet 12. In some examples, the first prism sheet 11 may be referred to as an upper prism sheet, and the second prism sheet 12 may be referred to as a lower prism sheet.

In some examples, as shown in FIGS. 2, 3 and 5, the first prism sheet 11 may have a first surface M1 and a second surface M2 which are opposite to each other. The first surface M1 may include a plurality of first dimming portions 130 extending in the first direction D1 and arranged in an array. In some examples, an orthographic projection of the first prism sheet 11 on the second surface may be substantially rectangular. The first prism sheet 11 may also have two first side surfaces 11a and two third side surfaces 11b that connect the first surface M1 and the second surface M2. The two first side surfaces 11a may extend in a third direction X and are disposed opposite to each other in a fourth direction Y. The two third side surfaces 11b may extend in the fourth direction Y and be arranged opposite to each other in the third direction X. The first side surface 11a may connect an edge of the first surface M1 in the fourth direction Y and an edge of the second surface M2 on the same side in the fourth direction Y, and the third side surface 11b may connect an edge of the first surface M1 in the third direction X and an edge of the second surface M2 on the same side in the third direction X. For example, the two first side surfaces 11a and the two third side surfaces 11b may all be perpendicular to the second surface M2. The third direction X may be perpendicular to the fourth direction Y. A plane where the third direction X and the fourth direction Y are located may be a horizontal plane, the third direction X may be parallel to a horizontal line, and a fifth direction Z may be perpendicular to the plane where the third direction X and the fourth direction Y are located. The fifth direction Z may be a thickness direction of the first prism sheet 11 and the second prism sheet 12. The first direction D1 may intersect with both the third direction X and the fourth direction Y. An included angle between the first direction D1 and the third direction X may be a first cutting angle a1 of the first prism sheet 11.

In some examples, as shown in FIGS. 2, 4 and 6, the second prism sheet 12 may have a third surface M3 and a fourth surface M4 which are opposite to each other. The third surface M3 may include a plurality of second dimming portions 140 extending in the second direction D2 and arranged in an array. In some examples, an orthographic projection of the second prism sheet 12 on the fourth surface may be substantially rectangular. The second prism sheet 12 may also have two second side surfaces 12a and two fourth side surfaces 12b that connect the third surface M3 and the fourth surface M4. The two second side surfaces 12a may both extend in the third direction X and are disposed opposite to each other in the fourth direction Y. The two fourth side surfaces 12b may both extend in the fourth direction Y and be arranged opposite to each other in the third direction X. The second side surface 12a may connect an edge of the third surface M3 in the fourth direction Y and an edge of the fourth surface M4 on the same side in the fourth direction Y, and the fourth side surface 12b may connect an edge of the third surface M3 in the third direction X and an edge of the fourth surface M4 on the same side in the third direction X. For example, the two third side surfaces 12a and the two fourth side surfaces 12b may all be perpendicular to the fourth surface M4. An included angle between the second direction D2 and the third direction X may be a second cutting angle a2 of the second prism sheet 12. The first cutting angle a1 may be different from the second cutting angle a2 such that the first direction D1 intersects with the second direction D2. For example, an included angle between the first direction D1 and the second direction D2 may be greater than 0 and less than 90 degrees. In some examples, the included angle between the first direction D1 and the second direction D2 may be 65 degrees to 75 degrees, for example, may be 70 degrees. The included angle between the first direction D1 and the second direction D2 in the present example may be a clockwise included angle or a counterclockwise included angle between the first direction D1 and the second direction D2.

In some examples, a difference between the absolute value of the second cutting angle a2 and the absolute value of the first cutting angle a1 may range from 10 degrees to 70 degrees. As shown in FIG. 5, the absolute value of the first cutting angle a1 may be greater than or equal to 20 degrees and less than or equal to 40 degrees. For example, the absolute value of the first cutting angle a1 may be greater than or equal to 25 degrees and less than or equal to 33 degrees. As shown in FIG. 6, the absolute value of the second cutting angle a2 may be greater than or equal to 50 degrees and less than or equal to 90 degrees. For example, the absolute value of the second cutting angle is greater than or equal to 65 degrees and less than or equal to 80 degrees.

In some examples, as shown in FIG. 3, each of the first dimming portions 130 may include two first extension surfaces 131 and 132 extending in the first direction D1, and extended edges of the two first extension surfaces 131 and 132 intersect on a side away from the second surface M2. End portions of the two first extension surfaces 131 and 132 away from the second surface M2 may intersect at a first intersection line 133. An extension direction of the first intersection line 133 may be parallel to the first direction D1.

In some examples, as shown in FIG. 3, in a cross section perpendicular to the second surface M2 and perpendicular to the first direction D1, a shape of the cross section of the first dimming portion 130 of the first prism sheet 11 may be a triangle, for example, an isosceles triangle. An included angle between the first extension surface 131 and the second surface M2 may be substantially the same as an included angle between the first extension surface 132 and the second surface M2. The first extension surfaces 131 and 132 may be substantially symmetrical with respect to the first intersection line 133.

In some examples, as shown in FIG. 3, the included angle between the two first extension surfaces 131 and 132 is b1. b1 may be referred to as a top angle of the first dimming portion 130. In some examples, the included angle b1 between the two first extension surfaces 131 and 132 may be 87 degrees to 92 degrees, for example 90 degrees. By setting the included angle between the two first extension surfaces 131 and 132 to be approximately 90 degrees, a better brightness may be achieved. In some other examples, a filleted corner may be formed at a connecting position of the two first extension surfaces 131 and 132.

In some examples, as shown in FIG. 4, each of the second dimming portions 140 may include two second extension surfaces 141 and 142 extending in the second direction D2, and extended edges of the two second extension surfaces 141 and 142 intersect on a side away from the fourth surface M4. End portions of the two second extension surfaces 141 and 142 away from the fourth surface M4 may intersect at a second intersection line 143. An extension direction of the second intersection line 143 may be parallel to the second direction D2.

In some examples, as shown in FIG. 4, in a cross section perpendicular to the fourth surface M4 and perpendicular to the second direction D2, a shape of the cross section of the second dimming portion 140 of the second prism sheet 12 may be a triangle, for example, an isosceles triangle. An included angle between the second extension surface 141 and the fourth surface M4 may be substantially the same as an included angle between the second extension surface 142 and the fourth surface M4. The second extension surfaces 141 and 142 may be substantially symmetrical with respect to the second intersection line 143.

In some examples, as shown in FIG. 4, the included angle between the two second extension surfaces 141 and 142 is b2. b2 may be referred to as a top angle of the second dimming portion 140. For example, b2 may be equal to b1. In some examples, the included angle b2 between the two second extension surfaces 141 and 142 may be 87 degrees to 92 degrees for example 90 degrees. By setting the included angle between the two second extension surfaces 141 and 142 to be approximately 90 degrees, a better brightness may be achieved. In some other examples, a filleted corner may be formed at a connecting position of the two second extension surfaces 141 and 142.

In some examples, the second surface M2 of the first prism sheet 11 and the fourth surface M4 of the second prism sheet 12 may be planar or may be approximately planar surfaces. For example, the approximately planar surfaces allow for presence of bumps or depressions due to manufacturing processes. The second surface M2 may be parallel to the fourth surface M4.

In some examples, as shown in FIGS. 2 and 3, the plurality of first dimming portions 130 of the first prism sheet 11 may be continuously distributed in a direction perpendicular to the first direction D1, for example, end portions of first extension surfaces of two adjacent first dimming portions 130 are connected to each other. In some other examples, the plurality of first dimming portions 130 may be distributed at intervals in the direction perpendicular to the first direction D1, that is, end portions of the first extension surfaces of two adjacent first dimming portions 130 may not be connected to each other. The present embodiment is not limited thereto.

In some examples, as shown in FIGS. 2 and 4, the plurality of second dimming portions 140 of the second prism sheet 12 may be continuously distributed in a direction perpendicular to the second direction D2, for example, end portions of the second extension surfaces of two adjacent second dimming portions 140 are connected to each other. In some other examples, the plurality of second dimming portions 140 may be distributed at intervals in the direction perpendicular to the second direction D2, that is, end portions of the second extension surfaces of two adjacent second dimming portions 140 may not be connected to each other. The present embodiment is not limited thereto.

In some examples, as shown in FIG. 3, a distance between the first intersection lines 133 of two adjacent first dimming portions 130 may be a first dimming pitch L1 of the first prism sheet. As shown in FIG. 4, a distance between the second intersection lines 143 of two adjacent second dimming portions 140 may be a second dimming pitch L2 of the second prism sheet. The first dimming pitch L1 and the second dimming pitch L2 may be substantially the same.

In some examples, as shown in FIG. 3, the first prism sheet 11 may include a first substrate 110, a first prism layer located on a side of the first substrate 110, and a first coating 111 located on a side of the first substrate 110 away from the first prism layer. The first prism layer may include a plurality of first dimming portions 130. The second surface M2 of the first prism sheet 11 may be a surface of the first coating 111 away from the first substrate 110. The first coating 111 may be configured to provide protection, and enhance wear resistance and scratch resistance, so as to prevent damages to the first prism layer.

In some examples, as shown in FIG. 4, the second prism sheet 12 may include a second substrate 120, a second prism layer located on a side of the second substrate 120, and a second coating 121 located on a side of the second substrate 120 away from the second prism layer. The second prism layer may include a plurality of second dimming portions 140. The fourth surface M4 of the second prism sheet 12 may be a surface of the second coating 121 away from the second substrate 120. The second coating 121 may be configured to provide protection, and enhance wear resistance and scratch resistance, so as to prevent damages to the second prism layer.

In some examples, the first substrate 110 and the second substrate 120 may be made of a Polyethylene Terephthalate (PET) material, which has good transparency and maximum toughness among thermoplastics to ensure structural firmness of the prism sheets. In addition, the PET material has good electrical insulation performance and is less affected by temperature, which may ensure the stability of the optical properties of the prism sheets.

In some examples, materials of the first coating 111 and the second coating 121 may be a variety of resin-based polymers, such as polyethylene, polystyrene and other materials. Resin polymer has good transparency, which may ensure optical performance of the prism sheets. In this example, hazes of the first prism sheet 11 and the second prism sheet 12 may be adjusted by providing the first coating and the second coating. Haze is a percentage of a transmitted light intensity that deviates from the incident light at an angle of more than 2.5° to a total transmitted light intensity. The greater the haze, the lower the gloss and transparency of the thin film, especially the lower the imaging sharpness.

In some examples, refractive indices of the first dimming portions 130 and the second dimming portions 140 may be 1.45 to 1.7, for example, 1.5 to 1.6. In some examples, the first dimming portions 130 and the second dimming portions 140 may be made of a same material, and have the same refractive index. In some other examples, the first dimming portions 130 and the second dimming portions 140 may have different refractive indices. The present embodiment is not limited thereto. By setting the refractive indices of the dimming portions to be less than or equal to 1.6, the scratch resistance of the prism sheets may be ensured.

In some examples, viewing angle is one of important specifications of a display device, and TCO international standards have clear requirements on viewing angles. Viewing angles may include Horizontal Viewing Angle and Vertical Viewing Angle. Horizontal viewing angle refers to an angle range that can be observed from the left side to the right side of a display screen in the horizontal direction. Horizontal viewing angle can indicate a width range that users can see contents on the screen when using the display normally. Vertical viewing angle refers to an angle range that can be observed from the top to the bottom of a display screen in the vertical direction. Vertical viewing angle can indicate a height range that users can see contents on the screen when using the display normally.

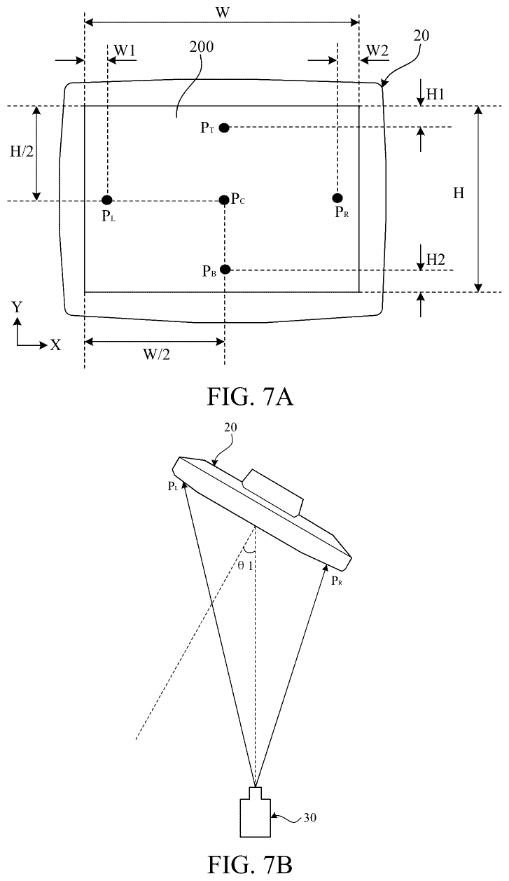

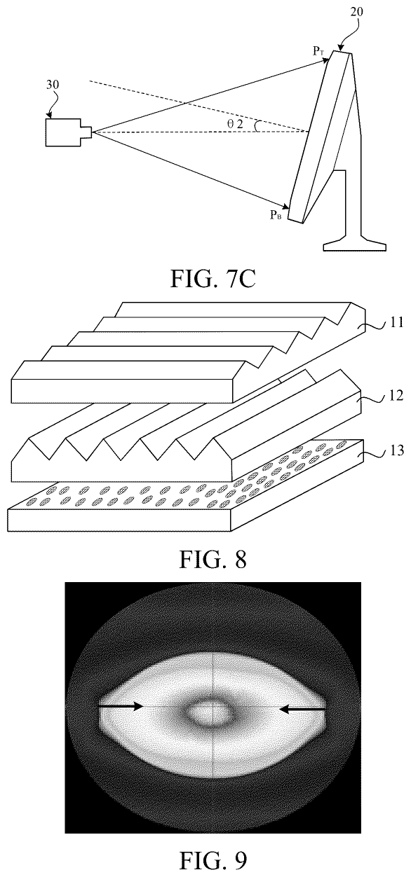

FIG. 7A is a schematic diagram of a display area of a liquid crystal panel according to at least one embodiment of the present disclosure. FIG. 7B is an observation view of the liquid crystal panel shown in FIG. 7A when measuring a horizontal viewing angle. FIG. 7C is an observation view of the liquid crystal panel shown in FIG. 7A when measuring a vertical viewing angle.

In some examples, as shown in FIGS. 7A to 7C, the liquid crystal panel 20 may have a rectangular display area 200. This example uses a camera 30 for viewing angle measurement. A viewing distance between the camera 30 and the liquid crystal panel 20 (i.e., a vertical distance between the camera 30 and the liquid crystal panel 20) may be a common viewing distance, for example, it may be about 1 meter.

In some examples, as shown in FIG. 7A, the display area 200 may have a first position P_{L}, a second position P_{R}, a third position P_{T}, a fourth position P_{B} and a center position P_{C}. The first position P_{L} and the second position P_{R} may be respectively located on two sides, i.e., left side and right side, of the center position P_{C} in the third direction X. The first position P_{L} and the second position P_{R} may be located on a center line of the display area 200 in the fourth direction Y. The third position P_{T} and the fourth position P_{B} may be respectively located on two sides, i.e., upper side and lower side, of the center position P_{C} in the fourth direction Y. The third position P_{T} and the fourth position P_{B} may be located on a center line of the display area 200 in the third direction X.

In some examples, a length of the display area 200 in the third direction X may be W. A distance between the first position P_{L} and a boundary (e.g., left boundary) of the display area 200 in the third direction X is W1. A distance between the second position P_{R} and the other boundary (e.g., right boundary) of the display area 200 in the third direction may be W2. W1 may be equal to W2, for example, both are W/10.

In some examples, a length of the display area 200 in the fourth direction Y may be H. A distance between the third position P_{T} and one boundary (e.g., upper boundary) of the display area 200 in the fourth direction Y may be H1. A distance between the fourth position P_{B} and the other boundary (e.g., lower boundary) of the display area 200 in the fourth direction Y may be H2. H1 may be equal to H2, for example, both are H/10.

In some examples, when viewing the liquid crystal panel 20 using the camera 30, a frequency and a range of moving leftward and rightward are generally larger than a frequency and a range of moving upward and downward, and therefore the horizontal viewing angle of the liquid crystal panel 20 should be as larger as possible than the vertical viewing angle. When the camera 30 moves leftward or rightward and an included angle θ1 between a sight line and a central axis of the display area 200 is 30 degrees, if a brightness difference viewed between two opposite positions (i.e., the first position P_{L} and the second position P_{R}) of the display area 200 in the third direction X is greater than a preset value, it is considered that the viewing angle of the liquid crystal panel 20 in the horizontal direction is small and does not meet the requirement on horizontal viewing angle. When the camera 30 moves upward or downward and an included angle θ2 between the sight line and the central axis of the display area 200 is 15 degrees, if a brightness difference viewed between two opposite positions (i.e., the third position P_{T} and the fourth position P_{B}) of the display area 200 in the fourth direction Y is greater than a preset value, it is considered that the viewing angle of the liquid crystal panel 20 in the vertical direction is small and does not meet the requirement on vertical viewing angle. In some examples, the preset value may be 1.73, for example.

In some examples, a TCO horizontal viewing angle uniformity A_{Horizontal}, a first TCO vertical viewing angle uniformity A_{Vertical1}, and a second TCO vertical viewing angle uniformity A_{Vertical2} may be calculated by the following formulas:

$${A}_{Horizontal} = \frac{( \frac{{L}_{ma x + 30 °}}{{L}_{m i n + 30 °}} ) + ( \frac{{L}_{ma x - 30 °}}{{L}_{m i n - 30 °}} )}{2} ;$$

$${A}_{Vertical 1} = \frac{{L}_{ma x + 15 °}}{{L}_{m i n + 15 °}} ;$$

$${A}_{Vertical 2} = \frac{{L}_{m ax - 15 °}}{{L}_{m i n - 15 °}} .$$

Herein, L_{max+30°} represents the maximum brightness value obtained by testing when the observation angle θ1 is 30 degrees, and L_{min+30°} represents the minimum brightness value obtained by testing when the observation angle θ1 is 30 degrees. L_{max-30°} represents the maximum brightness value obtained by testing when the observation angle θ1 is −30 degrees, and L_{min-30°} represents the minimum brightness value obtained by testing when the observation angle θ1 is −30 degrees. L_{max+15°} represents the maximum brightness value obtained by testing when the observation angle θ2 is 15 degrees, and L_{min+15°} represents the minimum brightness value obtained by testing when the observation angle θ2 is 15 degrees. L_{max-15°} represents the maximum brightness value obtained by testing when the observation angle θ2 is-15 degrees, and L_{min-15°} represents the minimum brightness value obtained by testing when the observation angle θ2 is −15 degrees.

In some examples, the larger one of the first TCO vertical viewing angle uniformity A_{Vertical1} and the second TCO vertical viewing angle uniformity A_{Vertical2} may be selected as a TCO vertical viewing angle uniformity.

Based on testing principles of TCO horizontal viewing angle and TCO vertical viewing angle, in order to facilitate simulation, calculation of TCO viewing angle uniformity described above may be transformed into a brightness ratio of a center point under different viewing angles.

In some examples, horizontal viewing angles ∠A and ∠B may be calculated by the following formulas:

$$∠ A = 90 ° - {tan}^{- 1} ( \frac{1.5 D \times sin 60 °}{1.5 D \times cos 60 ° - 0.4 H} ) ;$$

$$∠ B = 90 ° - {tan}^{- 1} ( \frac{1.5 D \times sin 60 °}{1.5 D \times cos 60 ° + 0.4 H} ) .$$

In some examples, vertical viewing angles ∠E and ∠F may be calculated by the following formulas:

$$∠ E = 90 ° - {tan}^{- 1} ( \frac{1.5 D \times sin 75 °}{1.5 D \times cos 75 ° - 0.4 W} ) ;$$

$$∠ F = 90 ° - {tan}^{- 1} ( \frac{1.5 D \times sin 75 °}{1.5 D \times cos 75 ° + 0.4 W} ) .$$

Herein, D represents a diagonal dimension of the liquid crystal panel, His a length of the liquid crystal panel in the fourth direction Y, and W is a length of the liquid crystal panel in the third direction X.

According to the above formulas, the horizontal viewing angle and the vertical viewing angle required for brightness test can be calculated for liquid crystal panels of different sizes. When the value of the aspect ratio (i.e. H:W) of the liquid crystal panel is fixed, the values of the horizontal viewing angle and the vertical viewing angle obtained by the aforementioned formulas are fixed. For example, ∠A=17.17°, ∠B−40.22°, ∠E=7.55°, and ∠F=21.96° when H:W=16:9.

In some examples, the TCO viewing angle uniformity (including a TCO horizontal viewing angle uniformity A_{Horizontal}, a first TCO vertical viewing angle uniformity A_{Vertical1}, and a second TCO vertical viewing angle uniformity A_{Vertical2}) of the corresponding liquid crystal panel may be calculated according to the following formulas.

$${A}_{Horizontal} = \frac{( \frac{{L}_{+ 17.17 °}}{{L}_{+ 40 \text{.22} °}} ) + ( \frac{{L}_{- 17.17 °}}{{L}_{- 40.22 °}} )}{2} ;$$

$${A}_{Vertical 1} = \frac{{L}_{+ 7.55 °}}{{L}_{+ 21.96 °}} ;$$

$${A}_{Verical 2} = \frac{{L}_{- 7.55 °}}{{L}_{- 21.96 °}} .$$

FIG. 8 is a schematic diagram of a dimming assembly according to at least one embodiment of the present disclosure. In some examples, as shown in FIG. 8, the dimming assembly may include a diffuser 13, a second prism sheet 12, and a first prism sheet 11 that are stacked. The stacked structure may be referred to as a DPP (Diffuser+Prism+Prism) structure. The diffuser 13 may be located on a light-emitting side of a light source assembly, and may be configured to diffuse transmitted light, and direct the diffused light towards the second prism sheet 12. The diffuser 13 may function in light mixing. By providing the diffuser 13, the light emitted by a point light source or a line light source can be diffused to form a surface light source, so that the backlight module can provide a surface light source with sufficient brightness and uniform distribution. The diffuser 13 has high wrinkle resistance and light shielding properties.

In some examples, based on the DPP architecture, simulation tools (such as Light Tools) are used to simulate the brightness viewing angle distribution of the backlight module (backlight unit, BLU), and the TCO viewing angle uniformity of the backlight module can be calculated. The influence of the individual parameters of the prism sheet on the TCO viewing angle uniformity includes: the refractive indices of the dimming portions of the prism sheet, the haze of the prism sheet and the size of the top angle of the dimming portion significantly improve the viewing angle uniformity, while the change of dimming pitch and top angle radian has little influence on the viewing angle uniformity. Taking the backlight module based on DDP architecture (the backlight module based on DDP architecture can include two diffusers and a prism sheet that are stacked) as an example, by increasing the refractive index of the prism sheet, the simulation value of the TCO horizontal viewing angle uniformity of the backlight module can be improved from 3.68 to 3.28, and the simulation value of TCO vertical viewing angle uniformity can be improved from 1.77 to 1.64.

In some examples, according to the simulation test, it can be seen that the refractive index of the first dimming portion of the first prism sheet is increased by 0.01, the TCO horizontal viewing angle uniformity of the backlight module is reduced by 0.1, and the TCO vertical viewing angle uniformity is reduced by 0.06. The refractive index of the second dimming portion of the second prism sheet is increased by 0.01, the TCO horizontal viewing angle uniformity of the backlight module is reduced by 0.05, and the TCO vertical viewing angle uniformity is reduced by 0.05. The haze of the first prism sheet is increased by 10%, the TCO horizontal viewing angle uniformity of the backlight module is reduced by 0.01, and the TCO vertical viewing angle uniformity is reduced by 0.01. The haze of the second prism sheet is increased by 10%, the TCO horizontal viewing angle uniformity of the backlight module is reduced by 0.02, and the TCO vertical viewing angle uniformity is reduced by 0.04. The top angle of the dimming portion of the prism sheet is reduced by 10 degrees, the TCO horizontal viewing angle uniformity is reduced by 0.05 to 0.2, and the TCO vertical viewing angle uniformity is reduced by 0.2. The dimming pitch of the prism sheet is changed by 10 microns, and the TCO horizontal viewing angle uniformity and the TCO vertical viewing angle uniformity are increased by 0.01. When the top angle of the prism sheet is rounded, the radian of the top angle changes, which will increase both the TCO horizontal viewing angle uniformity and the TCO vertical viewing angle uniformity. According to the above simulation test results, it can be seen that the refractive index of the dimming portion of the prism sheet, the haze of the prism sheet and the size of the top angle of the dimming portion significantly improve the TCO viewing angle uniformity, while the changes of dimming pitch and top angle radian have little influence on the TCO viewing angle uniformity.

FIG. 9 is a schematic diagram showing an influence of a refractive index of a dimming portion of a prism sheet on a viewing angle. As shown in FIG. 9, the refractive index of the dimming portion of the prism sheet has a large influence on both the viewing angle and the brightness. The main influence of the refractive index on the optical viewing angle distribution shape is that it can bring about the contraction of the high-brightness region, as shown in the arrow direction in FIG. 9. Therefore, conventionally, the higher the refractive index, the worse the TCO viewing angle uniformity.

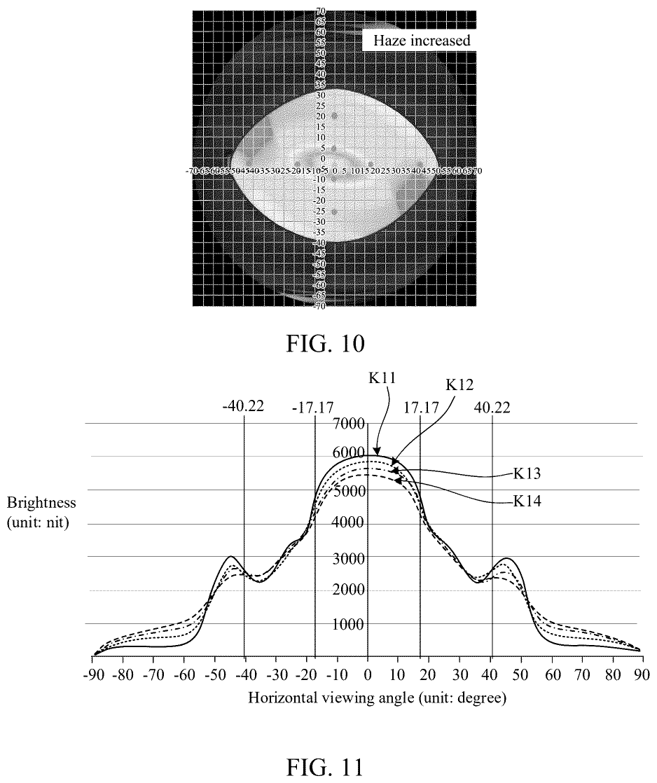

FIG. 10 is a schematic diagram showing an influence of a haze of a prism sheet on a viewing angle. As shown in FIG. 10, the haze expresses sharpness in the full viewing diagram, that is, the smoothness of the transition. When the haze of the prism sheet increases, the brightness of the high-brightness region will decrease, but the overall viewing angle distribution shape will not change, which is equivalent to the overall gray level of the high-brightness region becoming lighter, and the brightness is allocated to the low-brightness region.

FIG. 11 is a graph of a haze of a prism sheet influencing a viewing angle. In the graph shown in FIG. 11, the abscissa represents the horizontal viewing angle, the ordinate represents the brightness, and the unit is nits. Curve K11 represents a horizontal viewing angle brightness curve with a haze of 0%, curve K12 represents a horizontal viewing angle brightness curve with a haze of 7%, curve K13 represents a horizontal viewing angle brightness curve with a haze of 20%, and curve K14 represents a horizontal viewing angle brightness curve with a haze of 30%. It can be seen from FIG. 11 that when the horizontal viewing angles are 17.17 degrees and 40.22 degrees, the brightness decreases with the increase of haze, and when the horizontal viewing angle is 17.17 degrees, the brightness decreases faster with the increase of haze, which brings better TCO viewing angle uniformity.

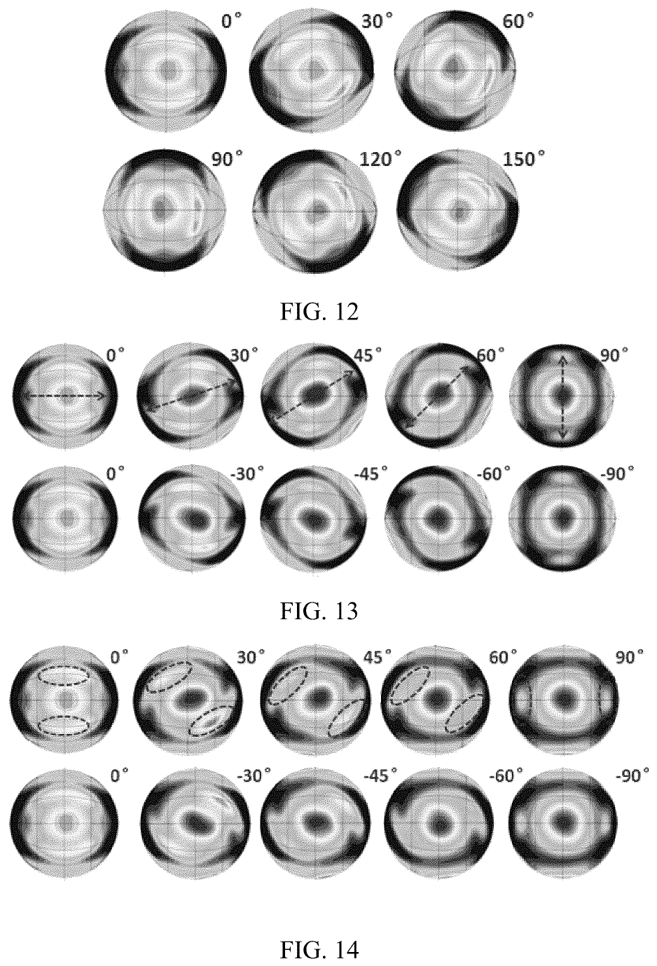

FIG. 12 is a brightness full viewing angle distribution diagram after a first prism sheet and a second prism sheet of a dimming assembly are rotated simultaneously. In this example, taking the first cutting angle of the first prism sheet as 0 degree and the second cutting angle of the second prism sheet as 0 degree as an example, the first prism sheet and the second prism sheet are simultaneously rotated counterclockwise by 0 degree to 180 degrees around a horizontal line (i.e., the third direction). During the rotation, an included angle between the extension direction of the first dimming portion of the first prism sheet (i.e., the first direction) and the extension direction of the second dimming portion of the second prism sheet (i.e., the second direction) is 0 degree. As can be seen from FIG. 12, the full viewing angle distribution shape remains unchanged, and only the corresponding angle is rotated.

FIG. 13 is a brightness full viewing angle distribution diagram after a second prism sheet of a dimming assembly is fixed and a first prism sheet is rotated. In the present example, the structures of the first prism sheet and the second prism sheet may be substantially the same. The second cutting angle of the second prism sheet is 0 degree, and the second prism sheet is fixed so that the first prism sheet is rotated counterclockwise around the horizontal line for one circle. During the rotation, the included angle between the extension direction of the first dimming portion of the first prism sheet (i.e., the first direction) and the extension direction of the second dimming portion of the second prism sheet (i.e., the second direction) changes. As can be seen from FIG. 13, a first central axis (dashed line with arrows in FIG. 13) of the full viewing angle distribution shape is rotated by the corresponding angle.

FIG. 14 is a brightness full viewing angle distribution diagram after a first prism sheet of a dimming assembly is fixed and a second prism sheet is rotated. In the present example, the structures of the first prism sheet and the second prism sheet may be substantially the same. The first cutting angle of the first prism sheet is 0 degree, and the first prism sheet is fixed so that the second prism sheet is rotated counterclockwise around the horizontal line for one circle. During the rotation, the included angle between the extension direction of the first dimming portion of the first prism sheet (i.e., the first direction) and the extension direction of the second dimming portion of the second prism sheet (i.e., the second direction) changes. It can be seen from FIG. 14 that two ends in a direction of a second central axis of the full viewing angle distribution shape (middle-brightness regions circled by the dash line in FIG. 14) will rotate by corresponding angles, and gradually darken as the rotation angle increases.

As can be seen from the brightness full viewing angle distribution diagrams of FIGS. 12 to 14, a direction of the first central axis of the full viewing angle distribution shape depends on the first cutting angle of the first prism sheet, and the brightness of the two ends in the direction of the second central axis of the full viewing angle distribution shape is related to the included angle between the first prism sheet and the second prism sheet (that is, the included angle between the extension direction of the first dimming portion of the first prism sheet and the extension direction of the second dimming portion of the second prism sheet). It can be seen that the first cutting angle of the first prism sheet and the included angle between the first prism sheet and the second prism sheet affect the TCO viewing angle uniformity.

In the following, the change rule of TCO viewing angle uniformity is studied by rotating the second prism sheet in the clockwise direction and the counterclockwise direction, respectively, with the first cutting angle of the first prism sheet as 0 degree. The included angle between the first prism sheet and the second prism sheet in the following refers to the included angle between the extension direction of the first dimming portion of the first prism sheet (that is, the first direction) and the extension direction of the second dimming portion of the second prism sheet (that is, the second direction).

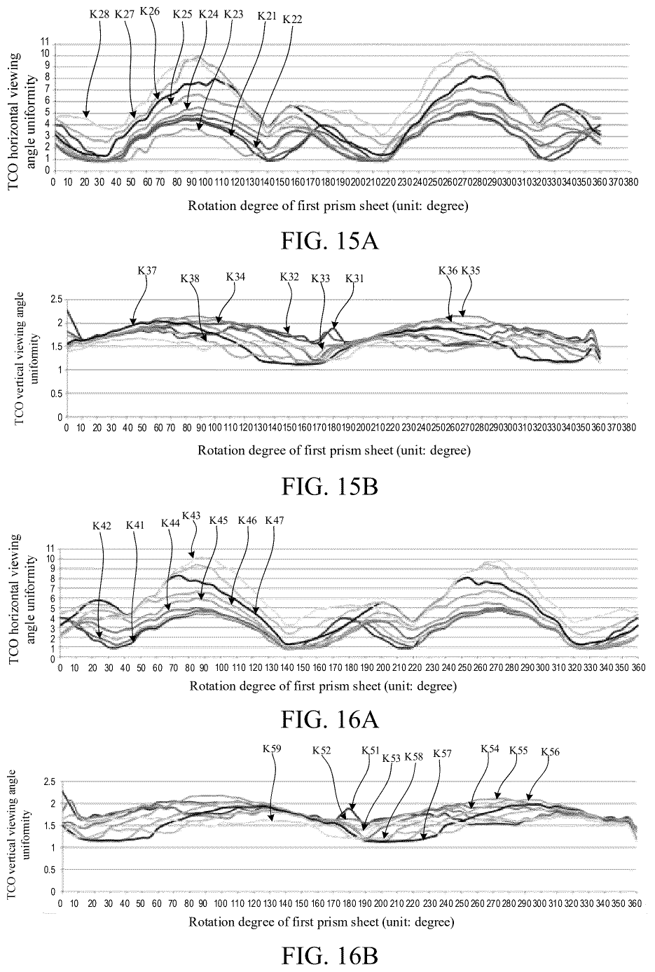

FIG. 15A is a graph showing a change in TCO horizontal viewing angle uniformity after a second prism sheet is rotated in a clockwise direction. FIG. 15B is a graph showing a change in TCO vertical viewing angle uniformity after a second prism sheet is rotated in a clockwise direction. FIG. 16A is a graph showing a change in TCO horizontal viewing angle uniformity after a second prism sheet is rotated in a counterclockwise direction. FIG. 16B is a graph showing a change in TCO vertical viewing angle uniformity after a second prism sheet is rotated in a counterclockwise direction.

The abscissa in FIGS. 15A to 16B represents a rotation angle of the first prism sheet, and the rotation angle of the first prism sheet is an included angle between the horizontal line and the first direction (that is, the extension direction of the first dimming portion) after rotation of the first prism sheet having the first cutting angle of 0 degree, which may be equivalent to the first cutting angle of the first prism sheet when the third direction is parallel to the horizontal line. The ordinates in FIGS. 15A and 16A represent TCO horizontal viewing angle uniformity, and the ordinates in FIGS. 15B and 16B represent TCO vertical viewing angle uniformity.

In FIG. 15A, curves K21 to K28 represent TCO horizontal viewing angle uniformity curves at different included angles between the first prism sheet and the second prism sheet. Curve K21 corresponds to an included angle between the first prism sheet and the second prism sheet of 0 degree. Curve K22 corresponds to an included angle between the first prism sheet and the second prism sheet of 10 degrees. Curve K23 corresponds to an included angle between the first prism sheet and the second prism sheet of 20 degrees. Curve K24 corresponds to an included angle between the first prism sheet and the second prism sheet of 45 degrees. Curve K25 corresponds to an included angle between the first prism sheet and the second prism sheet of 60 degrees. Curve K26 corresponds to an included angle between the first prism sheet and the second prism sheet of 70 degrees. Curve K27 corresponds to an included angle between the first prism sheet and the second prism sheet of 80 degrees. Curve K28 corresponds to an included angle between the first prism sheet and the second prism sheet of 90 degrees.

In FIG. 15B, curves K31 to K38 represent TCO vertical viewing angle uniformity curves at different included angles between the first prism sheet and the second prism sheet. Curve K31 corresponds to an included angle between the first prism sheet and the second prism sheet of 0 degree. Curve K32 corresponds to an included angle between the first prism sheet and the second prism sheet of 10 degrees. Curve K33 corresponds to an included angle between the first prism sheet and the second prism sheet of 20 degrees. Curve K34 corresponds to an included angle between the first prism sheet and the second prism sheet of 30 degrees. Curve K35 corresponds to an included angle between the first prism sheet and the second prism sheet of 45 degrees. Curve K36 corresponds to an included angle between the first prism sheet and the second prism sheet of 60 degrees. Curve K37 corresponds to an included angle between the first prism sheet and the second prism sheet of 70 degrees. Curve K38 corresponds to an included angle between the first prism sheet and the second prism sheet of 80 degrees.

In FIG. 16A, curves K41 to K47 represent TCO horizontal viewing angle uniformity curves at different included angles between the first prism sheet and the second prism sheet. Curve K41 corresponds to an included angle between the first prism sheet and the second prism sheet of 0 degree. Curve K42 corresponds to an included angle between the first prism sheet and the second prism sheet of 10 degrees. Curve K43 corresponds to an included angle between the first prism sheet and the second prism sheet of 20 degrees. Curve K44 corresponds to an included angle between the first prism sheet and the second prism sheet of 30 degrees. Curve K45 corresponds to an included angle between the first prism sheet and the second prism sheet of 45 degrees. Curve K46 corresponds to an included angle between the first prism sheet and the second prism sheet of 60 degrees. Curve K47 corresponds to an included angle between the first prism sheet and the second prism sheet of 70 degrees.

In FIG. 16B, curves K51 to K59 represent TCO vertical viewing angle uniformity curves at different included angles between the first prism sheet and the second prism sheet. Curve K51 corresponds to an included angle between the first prism sheet and the second prism sheet of 0 degree. Curve K52 corresponds to an included angle between the first prism sheet and the second prism sheet of 10 degrees. Curve K53 corresponds to an included angle between the first prism sheet and the second prism sheet of 20 degrees. Curve K54 corresponds to an included angle between the first prism sheet and the second prism sheet of 30 degrees. Curve K55 corresponds to an included angle between the first prism sheet and the second prism sheet of 45 degrees. Curve K56 corresponds to an included angle between the first prism sheet and the second prism sheet of 60 degrees. Curve K57 corresponds to an included angle between the first prism sheet and the second prism sheet of 70 degrees. Curve K58 corresponds to an included angle between the first prism sheet and the second prism sheet of 80 degrees. Curve K59 corresponds to an included angle between the first prism sheet and the second prism sheet of 90 degrees.

As can be seen from FIGS. 15A to 16B, when the included angle between the first prism sheet and the second prism sheet is 0 degree, the optimal TCO horizontal viewing angle uniformity corresponds to two rotation positions of the first prism sheet. One of the two rotation positions corresponds to the rotation angle of the first prism sheet of 30 degrees and 210 degrees, and the other of the two rotation positions corresponds to the rotation angle of the first prism sheet of 150 degrees and 330 degrees. When the included angle between the first prism sheet and the second prism sheet is greater than 0 degree, and when the second prism sheet is rotated clockwise, the optimum TCO horizontal viewing angle uniformity corresponds to a rotation position of the first prism sheet, where the rotation angle of the first prism sheet is about 30 degrees and 210 degrees. When the included angle between the first prism sheet and the second prism sheet is greater than 0 degree, and when the second prism sheet is rotated counterclockwise, the optimum TCO horizontal viewing angle uniformity corresponds to a rotation position of the first prism sheet, where the rotation angle of the first prism sheet is about 150 degrees and 330 degrees. Thus, when the first cutting angle of the first prism sheet is 30 degrees or −30 degrees, the optimal TCO horizontal viewing angle uniformity can be obtained.

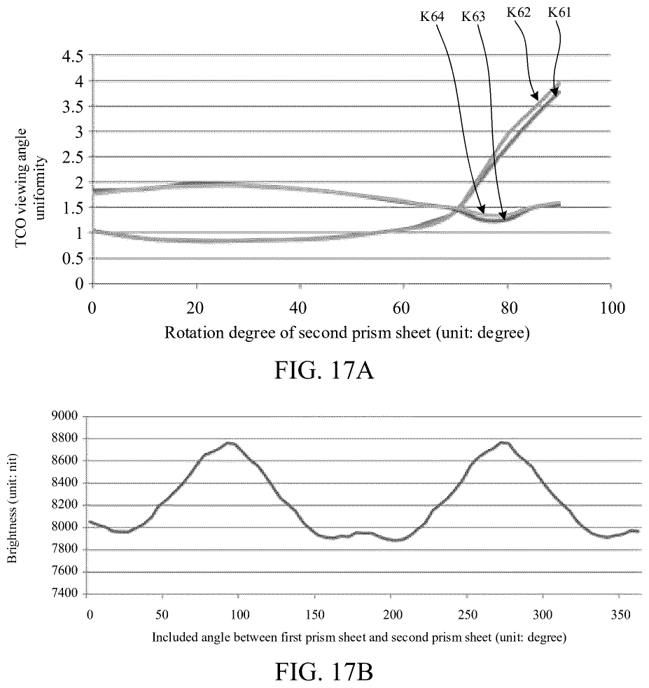

FIG. 17A is a graph of TCO viewing angle uniformity as a function of a rotation angle of a second prism sheet. FIG. 17B is a graph of brightness as a function of an included angle between a first prism sheet and a second prism sheet. The abscissa in FIG. 17A represents the rotation angle of the second prism sheet, and the ordinate in FIG. 17A represents the TCO viewing angle uniformity. The abscissa in FIG. 17B is the size of the included angle between the first prism sheet and the second prism sheet, and the ordinate in FIG. 17B is the brightness with unit of nits.

Curve K61 in FIG. 17A represents a curve of change in the TCO horizontal viewing angle uniformity after the second prism sheet is rotated clockwise with the first cutting angle of the first prism sheet as 30 degrees. Curve K62 is a curve of change in the TCO horizontal viewing angle uniformity after the second prism sheet is rotated counterclockwise with the first cutting angle of the first prism sheet as 150 degrees (i.e. −30 degrees). Curve K63 is a curve of change in the TCO vertical viewing angle uniformity after the second prism sheet is rotated clockwise with the first cutting angle of the first prism sheet as 30 degrees. Curve K64 is a curve of change in the TCO vertical viewing angle uniformity after the second prism sheet is rotated counterclockwise with the first cutting angle of the first prism sheet as 150 degrees.

As can be seen from FIG. 17A, at a position where the included angle between the first prism sheet and the second prism sheet is about 70 degrees, both the TCO horizontal viewing angle uniformity and the TCO vertical viewing angle uniformity are good. As can be seen from FIG. 17B, at a position where the included angle between the first prism sheet and the second prism sheet is about 90 degrees, the brightness is maximum, and the brightness gradually decreases as the included angle degree decreases in a range from 40 degrees to 90 degrees.

In combination with the above analysis of the refractive index of the prism sheet, the influence of the haze on the viewing angle, and the analysis of the influence of the included angle between the double prism sheets, it can be seen that by increasing the refractive indices of the dimming portions of the first prism sheet and the second prism sheet, the TCO viewing angle uniformity can be reduced and the brightness can be increased; by increasing the haze of the first prism sheet and the second prism sheet, the TCO viewing angle uniformity can be reduced, and the brightness can be reduced; by selecting prism sheets with appropriate cutting angles, the brightness of a large viewing angle can be improved on the basis of improving the brightness by changing the refractive index or haze, which can have a positive impact on the TCO viewing angle uniformity.

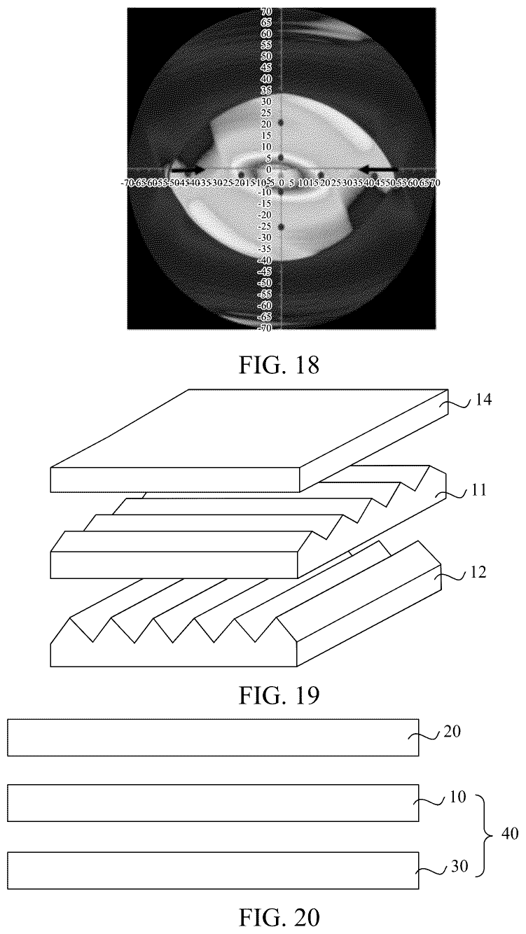

FIG. 18 is a brightness full viewing angle distribution diagram taking into account an influence of an included angle between a first prism sheet and a second prism sheet and refractive indices of a first dimming portion and a second dimming portion. In some examples, as shown in FIG. 18, the TCO horizontal viewing angle uniformity is 1.315 when the included angle between the first prism sheet and the second prism sheet is 70 degrees, and the TCO horizontal viewing angle uniformity is 1.625 when the included angle between the first prism sheet and the second prism sheet is 75 degrees. Assuming that the conversion ratio between the TCO viewing angle uniformity of the backlight module and the liquid crystal panel is 1.2, the included angle between the first prism sheet and the second prism sheet can be set to 70 degrees to balance the requirements of the viewing angle and the brightness of the liquid crystal panel.

According to the above analysis and testing, the absolute value of the first cutting angle of the first prism sheet may range from 20 degrees to 40 degrees, such as 25 degrees to 33 degrees, for example, the first cutting angle may be about 30 degrees or −30 degrees. The absolute value of the second cutting angle of the second prism sheet may range from 50 degrees to 90 degrees, such as from 65 degrees to 80 degrees. The included angle between the first prism sheet and the second prism sheet can be designed by setting the cutting angles of the first prism sheet and the second prism sheet. For example, the included angle between the first prism sheet and the second prism sheet can range from 65 degrees to 75 degrees, for example, the included angle between the first prism sheet and the second prism sheet can be about 70 degrees, so as to balance the requirements of the viewing angle and the brightness. When the second cutting angle of the second prism sheet is lower than 65 degrees, the brightness loss is serious. When the second cutting angle of the second prism sheet is higher than 80 degrees, TCO viewing angle uniformity cannot be achieved. The range setting of the cutting angles of the first prism sheet and the second prism sheet in the present example can balance the requirements of the viewing angle and the brightness.

According to the above analysis and testing, the higher the refractive indices of the dimming portions of the prism sheet, the higher the brightness, and the better the TCO viewing angle uniformity. However, when the refractive indices of the dimming portions are greater than 1.6, the scratch resistance of the prism sheet decreases significantly. The refractive indices of the dimming portions of the prism sheet of the present example may range from 1.45 to 1.7, such as 1.5 to 1.6. In the case where the first prism sheet and the second prism sheet have appropriate cutting angles, the refractive index can be fully utilized to meet the requirements of the brightness and the viewing angle.

From the above analysis and testing, it is known that the haze of the first prism sheet may range from 10% to 45%, such as 15% to 30%. When the haze of the first prism sheet is less than 15%, the shielding property is poor, and when the haze of the first prism sheet is greater than 30%, the brightness loss is significant. The haze of the second prism sheet may range from 10% to 45%. For example, it may be 25% to 45%. When the haze of the second prism sheet is lower than 25%, the TCO viewing angle uniformity cannot be achieved, and when the haze of the second prism sheet is higher than 45%, the brightness loss is significant. In the case where the first prism sheet and the second prism sheet have appropriate cutting angles, the haze can be fully utilized to meet the requirements of the brightness and the viewing angle.

FIG. 19 is another schematic diagram of a dimming assembly according to at least one embodiment of the present disclosure. In some examples, as shown in FIG. 19, the dimming assembly may include a second prism sheet 12, a first prism sheet 11, and a dual brightness enhancement film (DBEF) 14 that are stacked. The DBEF 14 may be located on a side of the first prism sheet 11 away from the second prism sheet 12, and the DBEF 14 is located on a light-emitting side of the first prism sheet 11. By providing the DBEF, the optical loss can be reduced and the brightness gain can be improved. The description of the first prism sheet 11 and the second prism sheet 12 may refer to the description of the foregoing embodiments, and therefore will not be repeatedly described here.

FIG. 20 is a schematic diagram of a display device according to at least one embodiment of the present disclosure. In some examples, as shown in FIG. 20, the display device may include a backlight module 40 and a liquid crystal panel 20 located on a light-emitting side of the backlight module 40. The backlight module 40 may include a light source assembly 30 and a dimming assembly 10. The dimming assembly 10 may be located between the liquid crystal panel 20 and the light source assembly 30. A structure of the dimming assembly 10 may be as described in the foregoing embodiments. The light source assembly 30 is configured to generate light directed towards the dimming assembly 10. The light emitted from the light source assembly 30 may sequentially pass through a second prism sheet and a first prism sheet of the dimming assembly 10 and be directed towards the liquid crystal panel 20. In some examples, the light source assembly 30 may include a back-in light source or a side-in light source. The present embodiment is not limited thereto. The backlight module and the display device of this example have advantages of small thickness, high gain and wide viewing angle.

In some examples, as shown in FIG. 20, the liquid crystal panel 20 may mainly include an array substrate, a cell-alignment substrate and a liquid crystal layer between the array substrate and the cell-alignment substrate. Types of the liquid crystal panel 20 may include a VA type, an IPS type, a TN type, and the like. The present embodiment is not limited thereto.

In some examples, the display device may be a mobile device, such as a smart phone, tablet computer, notebook computer, etc. The display device may be a wearable terminal, such as a smart watch, a smart bracelet, a smart eye, an augmented reality device, etc. The display device may be a fixed terminal, such as a desktop computer, a television, etc.

The drawings of the present disclosure only involve structures involved in the present disclosure, and other structures may refer to conventional designs. The embodiments of the present disclosure, i.e., features in the embodiments, may be combined with each other to obtain new embodiments if there is no conflict. It should be noted that the above examples or embodiments are exemplary only but not restrictive. Therefore, the present disclosure is not limited to what is specifically shown and described herein. Various modifications, substitutions, or omissions may be made in forms and details of implementations without departing from the scope of the present disclosure.

1. A dimming assembly, comprising:
a first prism sheet and a second prism sheet arranged opposite to each other; wherein the first prism sheet has a first surface and a second surface which are opposite to each other, the first surface comprises multiple first dimming portions which extend in a first direction and are arranged in an array; the first prism sheet further has at least one first side surface which extends in a third direction and connects the first surface and the second surface; an included angle between the third direction and the first direction is a first cutting angle of the first prism sheet; an absolute value of the first cutting angle is greater than or equal to 20 degrees and less than or equal to 40 degrees; and
the second prism sheet has a third surface and a fourth surface which are opposite to each other, the third surface is located on a side of the second prism sheet close to the first prism sheet; the third surface comprises multiple second dimming portions which extend in a second direction and are arranged in an array; an included angle between the first direction and the second direction is greater than 0 and less than 90 degrees.

2. The dimming assembly of claim 1, wherein the absolute value of the first cutting angle is greater than or equal to 25 degrees and less than or equal to 33 degrees.

3. The dimming assembly of claim 1, wherein the included angle between the first direction and the second direction ranges from 65 degrees to 75 degrees.

4. The dimming assembly of claim 1, wherein the second prism sheet has at least one second side surface which extends in the third direction and connects the third surface and the fourth surface, and an included angle between the third direction and the second direction is a second cutting angle of the second prism sheet; an absolute value of the second cutting angle is greater than the absolute value of the first cutting angle.

5. The dimming assembly of claim 4, wherein a difference between the absolute value of the second cutting angle and the absolute value of the first cutting angle ranges from 10 degrees to 70 degrees.

6. The dimming assembly of claim 4, wherein the absolute value of the second cutting angle is greater than or equal to 50 degrees and less than or equal to 90 degrees.

7. The dimming assembly of claim 5, wherein the absolute value of the second cutting angle is greater than or equal to 65 degrees and less than or equal to 80 degrees.

8. The dimming assembly of claim 1, wherein refractive indices of the first dimming portions of the first prism sheet and the second dimming portions of the second prism sheet range from 1.45 to 1.7.

9. The dimming assembly of claim 8, wherein the refractive indices of the first dimming portions of the first prism sheet and the second dimming portions of the second prism sheet range from 1.5 to 1.6.

10. The dimming assembly of claim 8, wherein a haze of the first prism sheet and a haze of the second prism sheet range from 10% to 45%.

11. The dimming assembly of claim 10, wherein an absolute value of a difference between the haze of the first prism sheet and the haze of the second prism sheet ranges from 5% to 30%.

12. The dimming assembly of claim 8, wherein each first dimming portion of the first prism sheet has two first extension surfaces extending in the first direction; in a cross section perpendicular to the second surface and perpendicular to the first direction, an included angle between the two first extension surfaces ranges from 87 degrees to 92 degrees.

13. The dimming assembly of claim 12, wherein each second dimming portion of the second prism sheet has two second extension surfaces extending in the second direction; in a cross section perpendicular to the fourth surface and perpendicular to the second direction, an included angle between the two second extension surfaces ranges from 87 degrees to 92 degrees.

14. The dimming assembly of claim 1, further comprising: a diffuser located on a side of the second prism sheet away from the first prism sheet, and configured to diffuse transmitted light and to direct diffused light toward the second prism sheet.

15. The dimming assembly of claim 1, further comprising: a dual brightness enhancement film located on a side of the first prism sheet away from the second prism sheet.

16. A backlight module, comprising a light source assembly and the dimming assembly of claim 1, wherein the light source assembly is configured to generate light directed towards the dimming assembly.

17. A display device, comprising the backlight module of claim 16 and a liquid crystal panel located on a light-emitting side of the backlight module.

18. The dimming assembly of claim 2, wherein refractive indices of the first dimming portions of the first prism sheet and the second dimming portions of the second prism sheet range from 1.45 to 1.7.

19. The dimming assembly of claim 3, wherein refractive indices of the first dimming portions of the first prism sheet and the second dimming portions of the second prism sheet range from 1.45 to 1.7.

20. The dimming assembly of claim 4, wherein refractive indices of the first dimming portions of the first prism sheet and the second dimming portions of the second prism sheet range from 1.45 to 1.7.
